(19) United States
(12) Patent Application Publication
(10) Pub. No.: US 2018/0178573 A1
(43) Pub. Date: Jun. 28, 2018

(54) OXIDATION RESISTANT GLASS-MOUNTED PHOTOGRAPH

(71) Applicant: HON HAI PRECISION INDUSTRY CO., LTD., New Taipei (TW)

(72) Inventors: FENG-YUEN DAI, New Taipei (TW); JIH-CHEN LIU, New Taipei (TW); HUNG-LIEN YEH, New Taipei (TW); CHIH-JUNG CHANG, New Taipei (TW); HUNG-CHUN MA, New Taipei (TW); HAN-LUNG LEE, New Taipei (TW); HAN-LUNG CHAO, New Taipei (TW); JAN-WAN CHANG, New Taipei (TW); CHEN-CHU CHIANG, New Taipei (TW); WEI-TING CHEN, New Taipei (TW)

(21) Appl. No.: 15/663,801

(22) Filed: Jul. 30, 2017

(30) Foreign Application Priority Data
Dec. 26, 2016 (TW) 105143211

(51) Int. Cl. B41M 7/00; B32B 17/06; B32B 7/12

(52) U.S. Cl. CPC B41M 7/0045; B32B 7/12; B32B 17/065

(57) ABSTRACT

A glass-mounted photograph includes a transparent plate with front and rear surfaces. A bonding layer is formed on the rear surface, and a pattern layer is formed on the bonding layer, the pattern layer being made from UV curable ink to present a picture that could have been photographed. The pattern layer of the oxidation-resistant glass-mounted photograph 100 is formed by spray printing color UV ink on the free surface of the bonding layer, when the UV ink is cured, the pattern layer is firmly formed on the surface of the transparent plate, and the pattern layer is an UV ink layer, the pattern layer 16 has an advantage of permanent preservation, and not become yellow as time goes on.

This application claims the benefit of priority under 35 USC 119 from Taiwan Patent Application 105143211, filed on Dec. 26, 2016.

### FIELD

The subject matter herein generally relates to photo manufacturing field, in particular to an oxidation-resistant glass-mounted photograph.

### BACKGROUND

A glass photo is a photograph mounted on a glass, a photograph layer being adhered on one surface of the glass by a layer of glue. However, the glue layer inside the glass photo is easily oxidized in the air and become yellow, thereby reducing the ornamental quality of the photograph and glass.

### BRIEF DESCRIPTION OF THE DRAWINGS

Implementations of the present technology will now be described, by way of example only, with reference to the attached figures.

FIG. 1 is an isometric view of an oxidation-resistant glass-mounted photograph in accordance with a first exemplary embodiment.

FIG. 2 is a cross-sectional view along line II-II of FIG. 1.

FIG. 3 is a cross-sectional view of an oxidation-resistant glass-mounted photograph in accordance with a second exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like. The references “a plurality of” and “a number of” mean “at least two.”

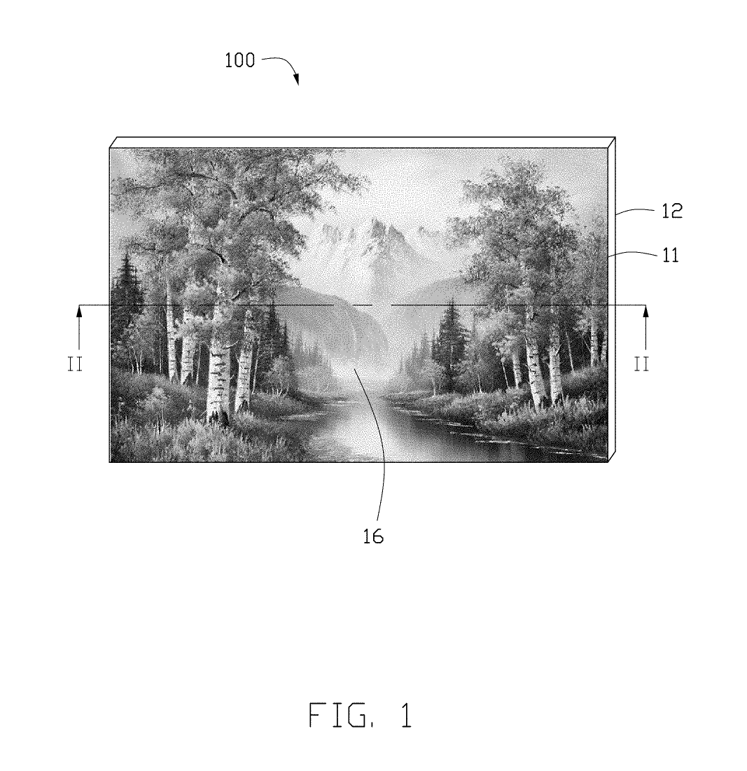

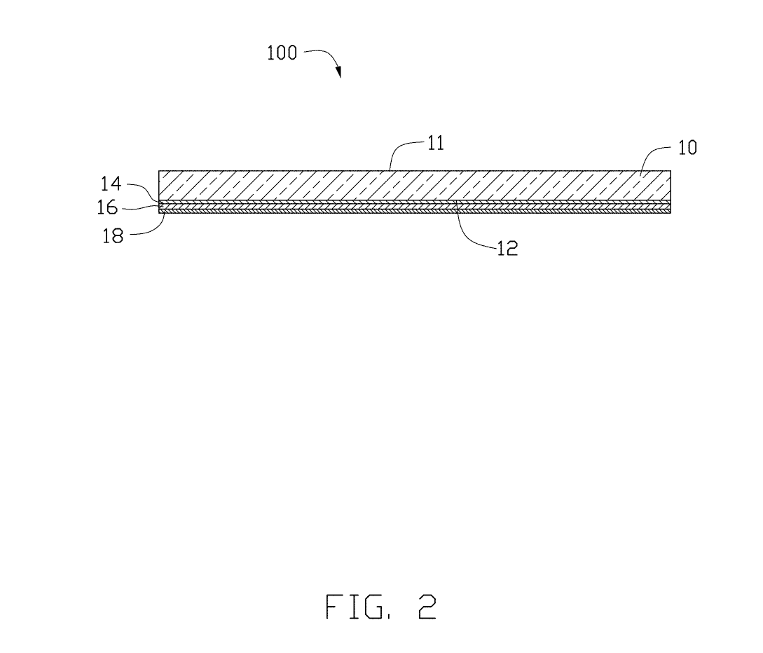

FIGS. 1-2 illustrate an oxidation-resistant glass-mounted photograph 100 according to an exemplary embodiment. FIG. 1 is an isometric view of an oxidation-resistant glass-mounted photograph in accordance with a first exemplary embodiment. FIG. 2 is a cross-sectional view along line II-II of FIG. 1. The oxidation-resistant glass-mounted photograph 100 includes a transparent plate 10, a bonding layer 14, a pattern layer 16, and a hard coating layer 18.

The transparent plate 10 is reinforced glass or acrylic material. Reinforced glass is tough. Acrylic material has advantages of light weight, high transparency, and easy machining. Using reinforced glass or acrylic material to manufacturing the oxidation-resistant glass-mounted photograph, and the manufacturing the oxidation-resistant glass-mounted has an advantage of avoid smash to pieces.

The transparent plate 10 can be a simple shape, such as prismatic shape, spherical shape, or cylindrical shape, and also can be a complicated shape, such as humanoid, animal shapes, flower shapes, or bird shapes. The transparent plate 10 includes a front surface 11 and a rear surface 12 opposite to the front surface 11. The front surface is a smooth surface, the rear surface is a smooth surface or a frosted surface, thereby, the oxidation-resistant glass-mounted photograph is able to show a different viewing effect according to the difference surface.

The bonding layer 14 is formed on the rear surface 12. The bonding layer 14 is configured to increase a contact force between the pattern layer 16 with the transparent plate 10, to prevent the pattern layer 16 from falling off the transparent plate 10. The bonding layer 14 is made of transparent and colorless material, such as an UV (ultraviolet) glue. A thickness range of the bonding layer 14 is about 5 micrometers to about 50 micrometers, is preferably about 5 micrometers. In a preferred embodiment, the bonding layer 14 is also can be omitted.

The pattern layer 16 is formed on the bonding layer 14. A thickness range of the pattern layer 16 is from about 5 micrometers to about 50 micrometers. The pattern layer 16 is a photograph formed by spray printing UV ink on the free surface of the bonding layer 14 using an inkjet printer, and the pattern layer 16 is printed on the bonding layer 14 according to an electronic file of the photograph storaged in an electronic product, and curing the UV ink on the free surface of the bonding layer 14. The electronic file of the pattern layer 16 is transmitted into the UV inkjet printer using blue tooth transmission, Wi-Fi transmission or USB transmission or other types of data transmission but not limited to the examples provided herein.

That is, the pattern layer 16 is an UV ink layer. The pattern layer 16 can be a portrait, a landscape scene, an animal picture, an auspicious pattern, a graining pattern, a leather pattern, or 3D image. Colors of the pattern layer 16 can be single color or color combinations. In this exemplary embodiment, the pattern layer 16 is a two-dimensional (2D) image, covering the entire bonding layer 14 and the free surface of bonding layer 14.

The hard coating layer 18 is formed on the pattern layer 16. The hard coating layer 18 is transparent and colorless and configured to protect the pattern layer 16, to prevent the pattern layer 16 from scratches. The hard coating layer 18 can be made of rigid resin, such as acrylic glass or polymethylmethacrylate (PMMA). A thickness range of the hard coating layer 18 is about 5 micrometers to about 50 micrometers, is preferably about 10 micrometers.

Because the hard coating layer 18 is colorless and transparent, and the pattern layer 16 is formed on the transparent plate 10, thereby, the oxidation-resistant glass-mounted photograph 100 can be viewed from the front, and also can be viewed from the rear. From the front side, a polished and reflective surface is seen, and from the rear side, a matte or fogged surface is seen.

In this exemplary embodiment, the hard coating layer 18 is composed of acrylic, titanium dioxide, and additives mixed at certain proportions under room temperature, and the hard coating layer 18 is able to enhance surface atomization. In a preferred exemplary embodiment, the additive comprises a dispersing agent, defoaming agent, photosensitizer, and light stabilizer, and the weight ratios of the acrylic, titanium dioxide, and antioxidant are respectively 65%˜75%, 15˜20%, and 5˜15%.

The pattern layer 16 in oxidation-resistant glass-mounted photograph 100 is formed by spraying UV curing ink on the bonding layer 14. Being protected by the hard coating layer 18, the pattern layer 16 has an advantage of permanent preservation and never turning yellow.

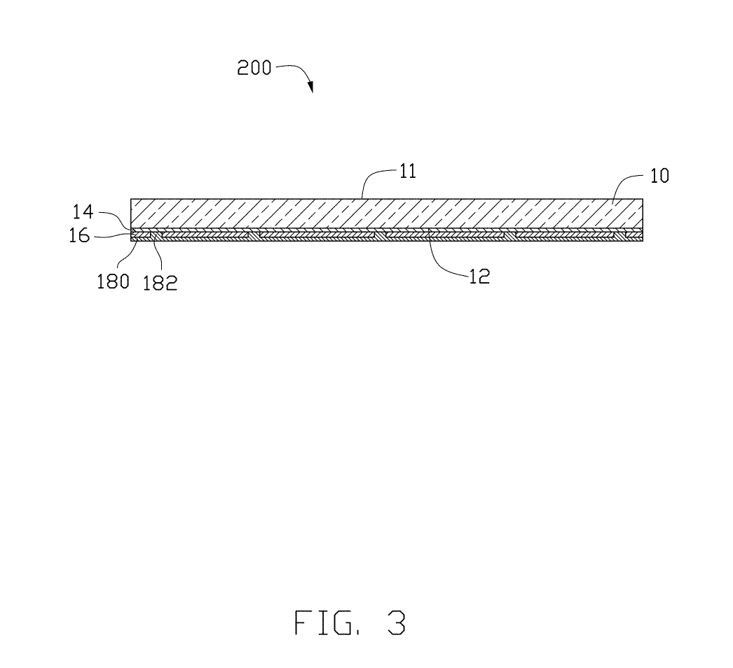

FIG. 3 illustrates an oxidation-resistant glass-mounted photograph 200 according to a second exemplary embodiment. FIG. 3 is a cross-sectional view of an oxidation-resistant glass-mounted photograph in accordance with a second exemplary embodiment. The oxidation-resistant glass-mounted photograph 200 is similar to the oxidation-resistant glass-mounted photograph 100 in FIG. 2. The differences between the oxidation-resistant glass-mounted photograph 200 and the oxidation-resistant glass-mounted photograph 100 in FIG. 1 is that the pattern layer 160 in glass photo 200 is a 3D image, and defines a plurality of pattern gaps 162 therein, and the hard coating layer 18 is filled into the pattern gaps 162. The pattern layer 160 is formed by control the thickness of the spray printing UV ink.

As described above, the pattern layer 16 of the oxidation-resistant glass-mounted photograph 100 is formed by spray printing color UV ink on the free surface of the bonding layer 14, when the UV ink is cured, the pattern layer 16 is firmly formed on the surface of the transparent plate 10, and the pattern layer 16 is an UV ink layer, the pattern layer 16 has an advantage of permanent preservation, and not become yellow as time goes on, thereby, the oxidation-resistant glass-mounted photograph has a better ornamental quality, and the oxidation-resistant glass-mounted photograph is made from reinforced glass or acrylic material, and avoid smash to pieces.

The exemplary embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. An oxidation resistant glass-mounted photograph, comprising:
a transparent plate comprising a front surface and a rear surface opposite to the front surface;
a bonding layer formed on the rear surface, and a pattern layer formed on the bonding layer; and
the pattern layer being made from UV curing ink.

2. The oxidation-resistant glass-mounted photograph of claim 1, wherein the transparent plate is made from reinforced glass or acrylic material.

3. The oxidation-resistant glass-mounted photograph of claim 1, further comprising a hard coating layer being formed on the pattern layer.

4. The oxidation-resistant glass-mounted photograph of claim 3, wherein the bonding layer is an UV glue.

5. The oxidation-resistant glass-mounted photograph of claim 4, wherein the hard coating layer is transparent and colorless.

6. The oxidation-resistant glass-mounted photograph of claim 3, wherein the hard coating layer is acrylic, titanium dioxide, and additives mixed at a predetermined proportion under room temperature.

7. The oxidation-resistant glass-mounted photograph of claim 6, wherein the additive comprises a dispersing agent, a defoaming agent, a photosensitizer and a light stabilizer.

8. The oxidation-resistant glass-mounted photograph of claim 6, wherein the predetermined proportion is a weight ratio, the weight ratio between the acrylic, titanium dioxide, and additives is 65%˜75%, 15˜20%, 5˜15%, respectively.

9. The oxidation-resistant glass-mounted photograph of claim 6, wherein the pattern layer is a 2D image and completely covers the rear surface.

10. The oxidation-resistant glass-mounted photograph of claim 6, wherein the pattern layer is a 3D image and defines a plurality of pattern gaps therein, and the hard coating layer is filled into the pattern gaps.

11. An oxidation-resistant glass-mounted photograph, comprising:
a transparent plate comprising a front surface and a rear surface opposite to the front surface;
a bonding layer being formed on the rear surface, and a pattern layer is formed on the bonding layer; wherein the pattern layer is an UV ink layer.

12. The oxidation-resistant glass-mounted photograph of claim 11, wherein the pattern layer is a 2D image and completely cover the rear surface.

13. The oxidation-resistant glass-mounted photograph of claim 11, wherein the pattern layer is a 3D image and defines a plurality of pattern gaps therein, and the hard coating layer is filled into the pattern gaps.

14. The oxidation-resistant glass-mounted photograph of claim 11, wherein further comprising a hard coating layer being formed on the pattern layer.

15. The oxidation-resistant glass-mounted photograph of claim 11, wherein a thickness range of the bonding layer is about 5 micrometers to about 50 micrometers.

16. The oxidation-resistant glass-mounted photograph of claim 11, wherein the hard coating layer is composed of acrylic, titanium dioxide and additives and is mixed at a certain proportion under room temperature.

17. The oxidation-resistant glass-mounted photograph of claim 16, wherein the additive comprises a dispersing agent, defoaming agent, photosensitizer and light stabilizer.

18. The oxidation-resistant glass-mounted photograph of claim 16, wherein the weight ratio of the acrylic, titanium dioxide, and additives are respectively in a range between 65%˜75%, 15˜20%, and 5˜15%.

19. The oxidation-resistant glass-mounted photograph of claim 11, wherein the front surface is a smooth surface, and the rear surface is a smooth surface or a frosted surface.
